(19) United States
(12) Patent Application Publication
(10) Pub. No.: US 2001/0023423 A1
(43) Pub. Date: Sep. 20, 2001

(54) Pseudo-random number generator

(75) Inventor: Fabrice Marinet, Chateauneuf-Le-Rouge (FR)

Correspondence Address: CHRISTOPHER F. REGAN, ESQUIRE, ALLEN, DYER, DOPPELT, MILBRATH & GILCHRIST, P.A., P.O. Box 3791, Orlando, FL, 32802-3791, US

(73) Assignee: STMicroelectronics S.A., Gentilly (FR)

(21) Appl. No.: 09/805,265

(22) Filed: Mar. 13, 2001

(30) Foreign Application Priority Data
Mar. 17, 2000 (FR) 00 03458

(51) Int. Cl. G06F 1/02

(52) U.S. Cl. 708/250

(57) ABSTRACT

A pseudo-random number generator includes a first generator for producing a sawtooth waveform signal having a first frequency, and a second generator for producing a pulse signal having a second frequency. A sampling circuit samples the sawtooth waveform signal and the pulse signal for generating a sample signal of the sawtooth waveform signal at the second frequency. A coding circuit codes the amplitude of the sample signal to supply binary values. The pseudo-random number generator has applications in integrated circuits which are used in contact type or contactless IC cards.

### FIELD OF THE INVENTION

The present invention relates to pseudo-random number generators which generate a time varying sequence of binary 1's or 0's, or binary codes in parallel.

### BACKGROUND OF THE INVENTION

Pseudo-random number generators are well known in the field of cryptography for encrypting and deciphering messages so as to make encrypted messages difficult, if not impossible, to read for anyone who does not possess the encryption/deciphering key. Such generators are for instance described in European patent application EP 878,907 and PCT patent applications WO 97/11423 and WO 97/43709.

In European patent application EP 878,907, the generator basically includes a first oscillator which supplies a sawtooth wave signal at a first frequency, and a second oscillator which generates a pulse train whose frequency is modulated by the sawtooth signal of the first oscillator.

In the generators according to patent applications WO 97/11423 and WO 97/43709, the randomness is obtained from a noise signal which is sampled and then encoded. These generators have the drawback of implementing many circuit elements, such as a noise source, a microprocessor, and ring oscillators. Consequently, these generators are not suited to some applications, such as integrated circuits for IC cards. This is whether the IC cards are of the contact or contactless type, in which it is important to use only a minimum number of elements to limit electrical power consumption.

### SUMMARY OF THE INVENTION

The invention thus proposes a pseudo-random number generator, characterized in that it comprises a first generator for producing a sawtooth waveform signal having a first frequency F1, a second generator for producing a pulse signal having a second frequency F2, and a sampling circuit for sampling the sawtooth waveform signal by the pulse signal to supply a sample signal. The pseudo-random number generator further includes a coding circuit for coding the amplitude of the sample signal to supply binary values in series or in parallel.

The coding circuit can be a comparator which supplies a binary value 1 or 0 depending on whether the amplitude of the sample is greater than or less than a certain threshold. The coding circuit can also be an analog-to-digital converter which supplies a parallel binary number representative of the amplitude of the sample.

### BRIEF DESCRIPTION OF THE DRAWINGS

Other characteristics and advantages of the present invention shall become apparent from reading the following description of an exemplary embodiment, given in conjunction with the appended drawings in which:

FIG. 1 is a block diagram of a pseudo-random number generator according to the present invention;

FIGS. 2A, 2B and 2C are signal timing charts according to the present invention;

FIG. 3 is a circuit diagram of a sawtooth waveform generator according to the present invention;

FIG. 4 is a circuit diagram of a pulse signal generator according to the present invention; and

FIG. 5 is a circuit diagram of a comparator according to the present invention.

### DETAILED DESCRIPTION OF THE PREFERRED EMBODIMENTS

The pseudo-random number generator according to the present invention comprises a sawtooth generator 10 producing a sawtooth signal at a frequency F1, and a pulse generator 12 producing a pulse signal at a frequency F2. The pulse signal at the frequency F2 is small relative to the frequency F1, which is on the order of five to ten times smaller.

The pseudo-random number generator further includes a sampling circuit 14 to which is applied the sawtooth signal at frequency F1 and the pulse signal at frequency F2. This sampling circuit supplies samples of the sawtooth signal at the frequency F2 of the pulse signal. A coding circuit 16 encodes the amplitude of each sample, and supplies binary numbers either in the form of a series of binary values, or in the form of codes composed of N binary values in parallel.

The pseudo-random number generator according to the invention can also comprise a reference voltage generator 22 generating reference voltages V⁺ and V⁻ which are applied to the sawtooth generator 10 and to the coding circuit 16. These reference voltages V⁺ and V⁻ define upper and lower values of the sawtooth waveform as well as end values for the comparison interval of the coding circuit 16.

In the case where the comparator is to produce a series of binary numbers, the coding circuit 16 comprises a comparator 18 which compares the amplitude of the sample signal with a median reference voltage Vref=(V⁺+V⁻)/2 of the sawtooth signal. The comparator 18 produces a signal representative of the binary digit 1 if the amplitude of the sample signal has a value greater than or equal to the median voltage, and a binary digit 0 if the amplitude of the sample signal has a value less than the median voltage.

Instead of this median voltage, it is proposed to use the mean voltage Vm of the sawtooth waveform voltage, which has the advantage of yielding a series of binary digits in which the number of 1 digits is substantially equal to the number of 0 digits over a length of time. The signal supplied by the comparator 18 is applied to a bistable circuit 20 which switches over to the state defined by the output signal of the comparator at the moment defined by the pulse signal of the generator 12.

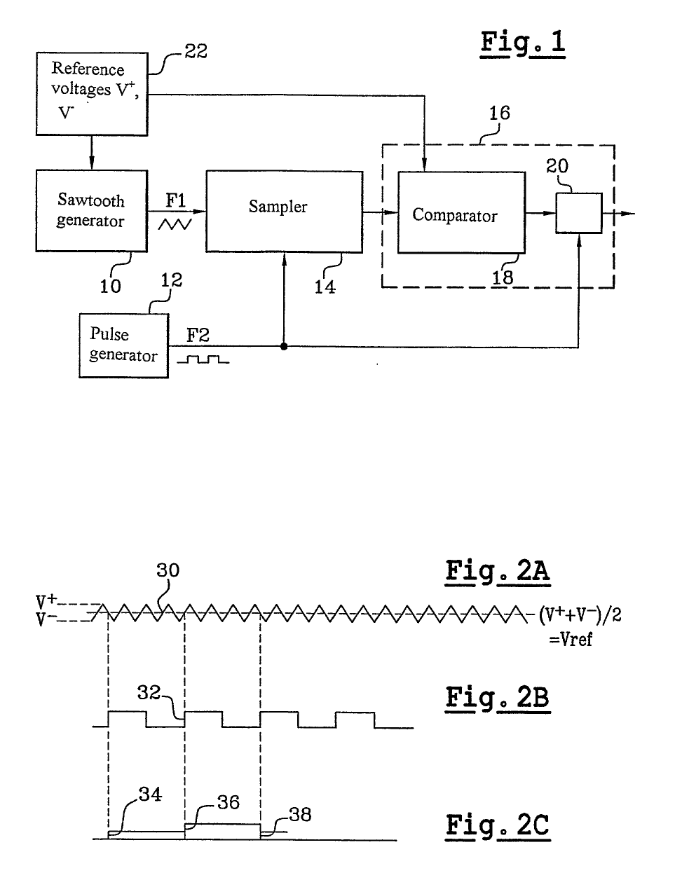

In the case where the generator is to produce codes composed of N binary digits in parallel, the comparator 18 is replaced by an analog-to-digital converter. This converter delivers the codes on N output conductors which are each connected to a bistable circuit, such as the one identified by reference numeral 20 in FIG. 1. The bistable circuit is switched over in synchronization with the pulse signal supplied by the generator 12.

The operation of the generator according to FIG. 1 is as follows. The generator 10 supplies a sawtooth waveform signal 30 as in FIG. 2A, whose amplitude varies between the reference values V⁺ and V⁻. This signal is sampled by the pulse signal 32 supplied by generator 12 in the sampling circuit 14, which supplies samples 34, 36 and 38 whose amplitudes are respectively less than, greater than, and less than the median voltage (V⁺+V⁻)/2. As a result, the comparator 18 supplies respectively and successively signals representative of binary digits 0, 1 and 0.

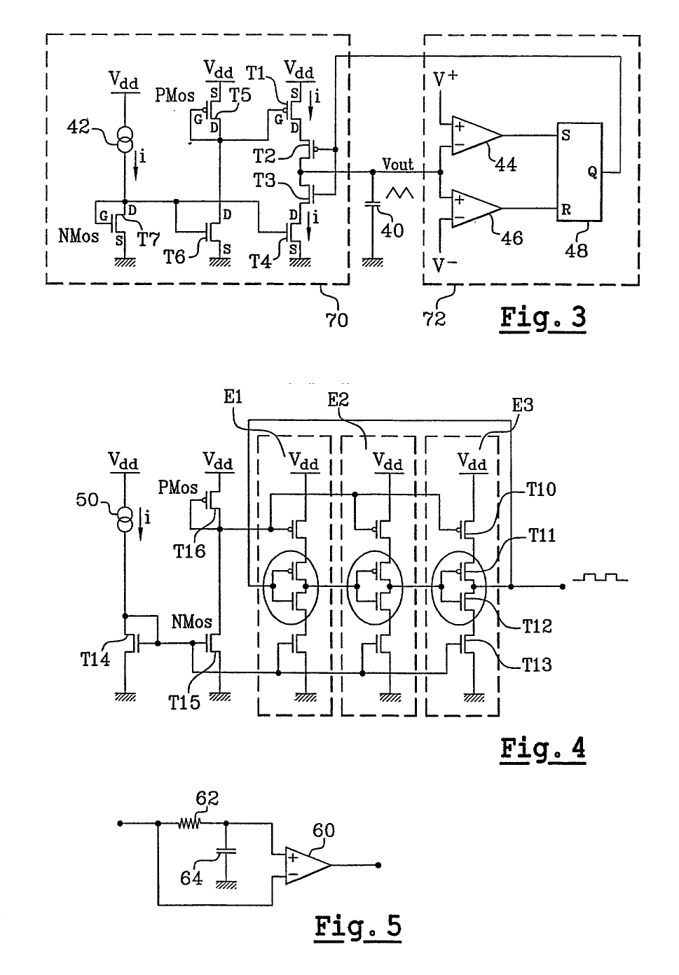

The sawtooth waveform generator 10 can be constructed in different ways, such as in accordance with the diagram of FIG. 3, for example. This embodiment comprises a capacitor 40 which is charged and discharged linearly by a current i supplied by a current generator 42. This current i is switched in a charge or discharge direction with respect to the capacitor 40 by a switching device 70 controlled by a control device 72.

The control device comprises two comparators 44 and 46 and a latch 48. The positive input terminal of comparator 44 receives reference voltage V⁺ while the negative input terminal is connected to the positive terminal of the capacitor 40, whose other terminal is connected to ground. The positive terminal of capacitor 40 is also connected to the positive input terminal of comparator 46, whose negative input terminal receives the reference voltage V⁻.

Comparator 44 supplies a set to the logic 1 signal to the latch 48 (S terminal) when the charge voltage Vout of the capacitor 40 is greater than or equal to V⁺. In a symmetrical manner, comparator 46 supplies a reset to the logic 0 signal to the latch 48 (R terminal) when the charge voltage Vout of the capacitor 40 is less than or equal to V⁻.

The output terminal Q of the latch 48 is connected to the switching device 70, which comprises transistors T1 to T7 and the current generator 42. More specifically, the Q terminal is connected to the gates of a P-MOS transistor designated T2 and an N-MOS transistor designated T3. The current i supplied by the current generator 42 supplies transistors T2 and T3 via current mirrors comprised of P-MOS transistors T5 and T1 for transistor T2, and comprised of N-MOS transistors T4, T6 and T7 for transistor T3. In these current mirrors, each of transistors T5 and T7 has its gate connected to its drain to form a diode.

The current generator 42 producing current i is connected directly to the power supply voltage Vdd and to ground via transistor T7. The drain D and gate G of transistor T7 are connected to the gate G of transistors T4 and T6. This defines the value of the current flowing in these two transistors T4 and T6, whose source S is connected to ground.

The drain and gate G of transistor T5 are connected to the gate G of transistor T1. This defines the value of the current flowing in transistor T1. The sources of transistors T1 and T5 are connected directly to the power supply voltage Vdd. The switching transistors T2 and T3 have their source S connected respectively to the drain D of transistors T1 and T4, with their source forming the common node which is connected to the positive terminal of capacitor 40.

The operation of the sawtooth waveform generator according to FIG. 3 is as follows. The capacitor 40 is charged by the current i flowing in transistors T1 and T2, and is discharged by the current i flowing in transistors T3 and T4. During the charging period, transistor T2 is conducting while transistor T3 is non-conducting. As soon as the charging voltage Vout of the capacitor 40 reaches V⁺, the comparator 44 and latch 48 change state, and so does the blocking transistor T2 and unblocking transistor T3. The capacitor 40 is then discharged by a current i so that when the charging voltage Vout reaches the lower value V⁻, the comparator 46 and bistable circuit 48 change state. The latter circuit supplies an unblocking signal to transistor T2 and a blocking signal to transistor T3.

The use of a current generator 42 associated with current mirrors makes it possible to obtain charging and discharging currents which are identical. The pulse signal generator 12 can be constructed in different ways, such as according to the diagram of FIG. 4. This embodiment comprises a ring oscillator having an odd number of stages, such as the three stages referenced E1, E2 and E3, for example. Each stage E1, E2 or E3 comprises four transistors in series T10 to T13. The transistors T10 and T11 are of the P-MOS type and transistors T12 and T13 are of the N-MOS type.

More specifically, each stage comprises an inverter circuit comprising the transistors T11 and T12. Each transistor T11 or T12 when conducting is driven by a transistor T10 or T13 which forms part of a current mirror. The voltage at the gate of transistor T10 is fixed by a P-MOS type transistor T16 which is diode connected by a gate-drain connection. Likewise, the voltage at the gate of transistor T13 is fixed by an N-MOS type transistor 14 which is diode connected by a gate-drain connection. Finally, an N-MOS type transistor T15 has its gate connected to the drain-gate common node of transistor T14. This fixes its voltage and hence the current flowing through transistor T16.

The value of the current i is fixed by a current generator 50 having one terminal connected to the supply voltage Vdd and the other terminal connected to the drain of transistor T14, whose source is connected to ground. In each stage, the source of transistor T13 is connected to ground while the source of transistor T10 is connected to the supply voltage Vdd.

The drain of each transistor T10 or T13 is connected respectively to the source of transistor T11 or T12. The drains of these transistors T11 and T12 are connected together to form the output terminal of the stage considered. The output terminal of stage E1 and of stage E2 is connected respectively to the gates of transistors T11 and T12 of the following stage E2 or E3. As for the output terminal of stage E3, it is connected to the gates of transistors T11 and T12 of stage E1.

By this looping of the output of stage E3 to the input of stage E1, there is obtained a ring oscillator whose operation is well known. The comparator 18 is for instance of the type according to the diagram of FIG. 5. This comparator comprises a comparator 60 whose negative input terminal is connected directly to the output terminal of the sampling circuit 14. The positive input terminal of the comparator 60 is also connected to the output terminal of the sampling circuit via an RC circuit comprising a resistor 62 and a capacitor 64.

In the pseudo-random number generator according to the invention, the randomness arises from the fact that signals of frequency F1 and F2 are asynchronous. It is pseudo random because there exists a correlation between two consecutive samples. This correlation shall be all the smaller as the ratio F1/F2 increases.

That which is claimed is:

1. A pseudo-random number generator, characterized in that it comprises:
a first generator (10) for producing a sawtooth waveform signal having a first frequency F1,
a second generator (12) for producing a pulse signal having a second frequency F2,
a sampling circuit (14) for sampling the sawtooth waveform signal by the pulse signal to supply a sample, and
a coding circuit (16) for coding the amplitude of the sample to supply binary values in series or in parallel.

2. Generator according to claim 1, characterized in that the coding circuit (16) is a comparator (60) which supplies a signal representative of a binary value 1 or 0 depending on whether the amplitude of the sample applied to an input terminal is greater than or less than a reference value (Vref) applied at the other input terminal.

3. Generator according to claim 2, characterized in that the reference value (Vref) is equal to the median excursion value of the saw tooth of the signal supplied by the first generator (10).

4. Generator according to claim 2, characterized in that the reference value (Vref) is equal to a mean value (Vm) of the amplitudes of the sample.

5. Generator according to claim 4, characterized in that the mean value (Vm) is obtained by an RC circuit (62, 64) to which the sampled signals are applied.

6. Generator according to claim 1, characterized in that the coding circuit is an analog-to-digital converter which supplies a binary code of N digits in parallel, representative of the amplitude of said sample.

7. Generator according to any one of the preceding claims 1 to 6, characterized in that the first generator (10) producing a sawtooth waveform signal of frequency F1 comprises:
a capacitor (40),
switching means (70) for switching a charging and discharging current (i) of said capacitor (40), and
switching control means (72) for controlling the switching of said current (i) to obtain a succession of charge and discharge cycles of said capacitor (40).

8. Generator according to claim 7, characterized in that said switching control means (72) comprise:
two comparators (44, 46) for each comparing the charging voltage (Vout) of said capacitor (40) to a reference value (V⁺, V⁻) and supplying a signal when the charging voltage (Vout) reaches the reference value (V⁺ or V⁻), and
a latch (48) for storing the signal supplied successively by each comparator.

9. Generator according to claim 7 or 8, characterized in that the switching means (70) for the charging and discharging current (i) of the capacitor (40) comprise:
a current generator (42) for supplying a constant current (i);
current mirrors (T1, T4 to T7) for reproducing the current (i) so as to enable the capacitor (40) to be supplied in both flow directions, and
a switch (T2, T3) controlled by the switching control means (72) for selecting the direction of current flow in said capacitor (40).

10. Generator according to any one of the preceding claims 1 to 9, characterized in that the second generator (12) producing a pulse signal having a second frequency F2 is a ring oscillator having an odd number of stages (E1, E2, E3), characterized in that:
each stage (E1, E2 or E3) comprises an inverter circuit having two transistors (T11, T12), each transistor (T11 or T12) being supplied by a transistor (T10 or T13) whose gate voltage is fixed by a transistor (T16 or T14) connected as a diode and supplied by a constant current (i) supplied by a current generator (50).
